(19) United States
(12) Patent Application Publication
(10) Pub. No.: US 2007/0025468 A1
(43) Pub. Date: Feb. 1, 2007

(54) GMSK/8-PSK mix-mode support for GSM/GPRS/EDGE compliant handsets

(76) Inventor: Weidong Li, Los Gatos, CA (US)

Correspondence Address: MCANDREWS HELD & MALLOY, LTD, 500 WEST MADISON STREET, SUITE 3400, CHICAGO, IL, 60661, US

(21) Appl. No.: 11/191,747

(22) Filed: Jul. 28, 2005

(51) Int. Cl. H04L 27/20; H04L 25/49

(52) U.S. Cl. 375/308; 375/297

(57) ABSTRACT

A GMSK/8-PSK mix-mode support for GSM/GPRS/EDGE compliant handsets is provided and may comprise transmitting bursts of different modulation types within a single GSM frame, where the different modulation types may comprise a GMSK modulated type and an 8-PSK modulated type. The method may comprise selecting the modulation type for each of the transmitted bursts in the single GSM frame. The GMSK modulated type may be used to modulate a normal data burst type and/or an access burst type. Data that may be transmitted within the single GSM frame may be stored in memory. At least a portion of the stored data may be selected for an initialization portion of the burst, and at least a portion of the stored data may be selected for a data portion of the burst.

### CROSS-REFERENCE TO RELATED APPLICATIONS/INCORPORATION BY REFERENCE

This application makes reference to: U.S. patent application Ser. No. ______ (Attorney Docket Number 16424US01) filed Jul. 28, 2005.

The above stated application is hereby incorporated herein by reference in its entirety.

### FIELD OF THE INVENTION

Certain embodiments of the invention relate to wireless communication. More specifically, certain embodiments of the invention relate to a method and system for GMSK/8-PSK mix-mode support for GSM/GPRS/EDGE compliant handsets.

### BACKGROUND OF THE INVENTION

The introduction of cellular communications systems in the late 1970's and early 1980's represented a significant advance in mobile communications. The networks of this period may be commonly known as first generation, or “1G,” systems. These systems were based upon analog, circuit-switching technology, and the most prominent of these systems may have been the advanced mobile phone system (AMPS). Second generation, or “2G,” systems ushered in performance improvements over 1 G systems and introduced digital technology to mobile communications. Exemplary 2G systems include the global system for mobile communications (GSM), digital AMPS (D-AMPS), and code division multiple access (CDMA). GSM, which may be the dominant standard for 2G systems, uses Gaussian minimum shift keying (GMSK) modulation format. The GMSK modulation is a binary modulation scheme of one bit per symbol. Some advantages of the GMSK format are compact output power spectrum and high immunity to noise and interference.

GSM uses time division multiple access (TDMA) technology that allows eight GSM devices to time-share each 200 kilohertz (KHz) radio frequency (RF) channel. These GSM devices are assigned to slots, or bursts, with each slot duration in time being 577 μs. Together, the eight slots form a frame with a corresponding duration of 4.615 ms. Corresponding channel capacity using GMSK modulation is 148 bits per time slot. In voice mode, the GSM device is always assigned one slot per frame for transmission of voice data. Similarly, a form of wireless data service called circuit-switched data allots a time slot in each frame to a GSM device whether there is data present or not. Circuit-switched operation is inherently inefficient because a slot is always assigned whether or not the mobile phone has any information to send. Additionally, in order to reduce power usage and interference to other mobile phones, a GSM phone ramps up to transmit and then ramps down after the transmission period for the slot. However, when the GSM phone transmits during its time slot when there is no information to send, power may be wasted and additional interference may occur.

General packet radio service (GPRS), which is an example of a 2.5G network service oriented for data communications, comprises enhancements to GSM that required additional hardware and software elements in existing GSM network infrastructures. Although GPRS also uses GMSK modulation, where GSM may only allot one time slot in a time division multiple access (TDMA) frame, GPRS may allot up to eight time slots in a TDMA frame, thereby providing a data transfer rate of up to 115.2 kbits/s. GPRS is simply an extension of the GSM standard to provide packet data services. Another 2.5G network, enhanced data rates for GSM evolution (EDGE), also comprises enhancements to GSM, and like GPRS, EDGE may allocate up to 8 time slots in a TDMA frame for packet-switched, or packet mode, transfers. However, unlike GPRS and GSM, EDGE uses 8 phase shift keying (8-PSK) modulation to achieve data transfer rates that may be as high as 384 kbits/s.

With 8-PSK modulation, there are eight distinct phase changes that a decoder may detect in the binary data. With every phase transition, the symbols may rotate an additional 67.5°, causing a shift of the I/Q constellation relative to its previous starting position. Although the 3 bits/symbol feature of the 8-PSK modulation format may provide high data rates, it is inherently prone to errors in the air interface due to the fast changing phase profile of the RF signal.

The GSM communication system allows the mobile phone to transmit in multiple slots, which may or may not be consecutive, within a frame as directed by the network. This permits a system operator to take advantage of dead air time associated with circuit-switched networks to increase capacity and data rates. For example, a mobile device in some systems may transmit a multiburst of up to four bursts in a frame. The mobile device may transmit the multiburst transmission using a single modulation scheme. This may allow for more efficient transmission since the modulator circuitry does not have to be ramped up and down for each slot. However, there may be times when it may be desired to transmit using different modulation schemes within the same multiburst. For example, if there is voice information in one slot that is modulated with GMSK, the other three slots may not be utilized to transmit data if the data is modulated with 8-PSK. Therefore, the capacity of those three slots may be wasted.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for GMSK/8-PSK mix-mode support for GSM/GPRS/EDGE compliant handsets, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a diagram illustrating exemplary GSM multiframe, which may be utilized in connection with an embodiment of the invention.

FIG. 1b is a diagram illustrating exemplary GMSK modulated burst and 8-PSK modulated burst in different GSM frames, which may be utilized in connection with an embodiment of the invention.

FIG. 1c is a diagram illustrating exemplary GMSK modulated burst and 8-PSK modulated burst in the same GSM frame, in accordance with an embodiment of the invention.

FIG. 1d is a block diagram of exemplary transmitter system of a mobile terminal, which may be utilized in connection with an embodiment of the invention.

FIG. 2a is a block diagram of exemplary transmission path, in accordance with an embodiment of the invention.

FIG. 2b is a block diagram of exemplary buffer for storing data for GMSK modulation and 8-PSK modulation, in accordance with an embodiment of the invention.

FIG. 3a is a timing diagram illustrating exemplary power ramp-up and ramp-down during transmission, in accordance with an embodiment of the invention.

FIG. 3b is a timing diagram illustrating exemplary multiburst transmission, in accordance with an embodiment of the invention.

FIG. 4 is a block diagram illustrating exemplary event control circuitry, in accordance with an embodiment of the invention.

FIG. 5 is a block diagram illustrating exemplary automatic power control block, in accordance with an embodiment of the invention.

FIG. 6 is a flow diagram illustrating exemplary routine for GMSK/8-PSK mix-mode support, in accordance with an embodiment of the invention.

### DETAILED DESCRIPTION OF THE INVENTION

Certain embodiments of the invention may be found in a method for GMSK/8-PSK mix-mode support for GSM/GPRS/EDGE compliant handsets, or mobile terminals. Aspects of the method may comprise transmitting bursts of different modulation types within a single GSM frame, wherein the different modulation types may comprise a GMSK modulated type and an 8-PSK modulated type. The method may comprise selecting the modulation type for each of the transmitted bursts in the single GSM frame. The GMSK modulated type may be used to modulate a normal data burst type and/or an access burst type. Data that may be transmitted within the single GSM frame may be stored in memory. At least a portion of the stored data may be selected for an initialization portion of the burst, and at least a portion of the stored data may be selected for a data portion of the burst.

In accordance with various aspects of the invention, transmit power may be ramped up prior to transmitting a first burst within the single GSM frame. A plurality of ramp-up values may be stored, for example, in memory, for use in ramping up the transmit power. Additional ramp-up values may be interpolated from the stored plurality of ramp-up values. An analog control signal may be generated from the stored plurality of ramp-up values and/or the interpolated ramp-up values to control ramping up of the transmit power. Similarly, transmit power may be ramped down after transmitting a last burst in the single GSM frame. A plurality of ramp-down values may be stored, for example, in memory, for use in ramping down transmit power. Additional ramp-down values may be interpolated from the stored plurality of ramp-down values. An analog control signal may be generated from the stored plurality of ramp-down values and/or the interpolated additional ramp-down values to control ramping down the transmit power.

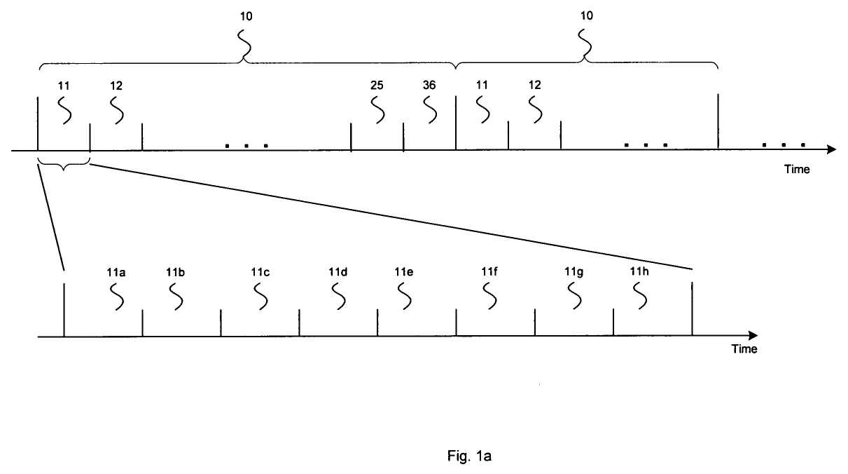

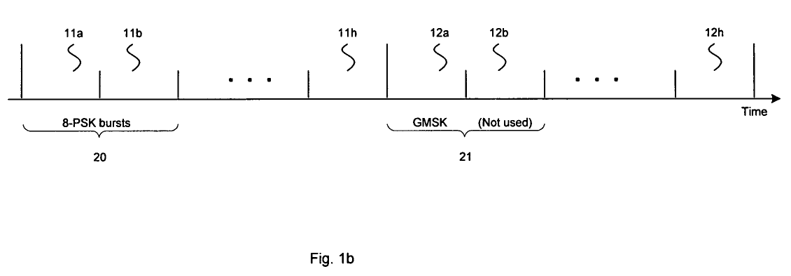

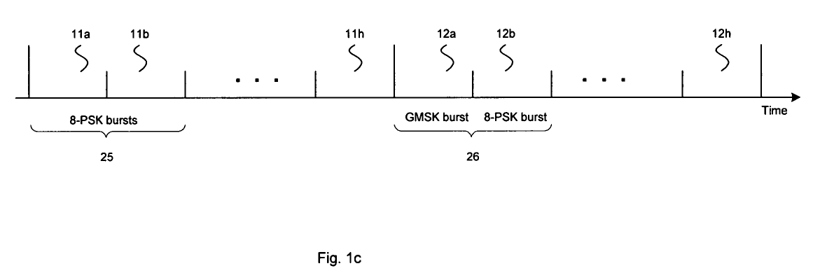

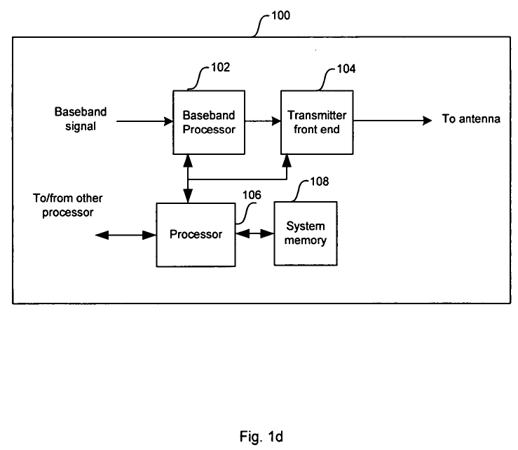

A GSM/GPRS/EDGE system may be used to communicate voice information and data information. GSM/GPRS/EDGE systems may transmit voce/data information in 200 KHz channels, and each channel may be time-multiplexed among various mobile terminals. The time multiplexing may be illustrated in FIG. 1a. FIG. 1a is a diagram illustrating exemplary GSM multiframe, which may be utilized in connection with an embodiment of the invention. Referring to FIG. 1a, there is shown a plurality of multiframes 10, where each multiframe may comprise twenty-six frames 11, . . . , 36. Two of these frames may be used for control and twenty-four frames may be used for user data communication. Each frame may comprise 8 bursts (or slots) a, b, . . . , h. A first burst in frame 11 may be referred to as burst 11a, and similarly the other seven bursts may be referred to as 11b, . . . , 11h.

A different mobile terminal may be assigned to each of the 8 different bursts a, b, . . . , h in a frame for voice communication. For example, a mobile terminal A may be assigned to a first burst in each frame and hence, may send data or voice information in burst 11a, then 12a, etc. A mobile terminal B may be assigned to a second burst in each frame and hence, may send data or voice information in burst 11b, then 12b, etc. This may be repeated for other multiframes for as long a period of time as the mobile terminal keeps the voice channel open. Voice information may be GMSK modulated, while data may be 8-PSK or GMSK modulated. However, the data throughput may be higher with 8-PSK modulation than with GMSK modulation. For example, data throughput using 8-PSK modulation may be as high as 384 kbits/s, as compared to 112.2 kbit/s for GMSK modulation. Accordingly, the higher data throughput of the 8-PSK modulation may be desired when sending data.

When a mobile terminal requests a data channel, the GSM/GPRS/EDGE system may allocate a number of sequential bursts, as the bursts may be available. This may be illustrated in FIG. 1b. FIG. 1b is a diagram illustrating exemplary GMSK modulated burst and 8-PSK modulated burst in different GSM frames, which may be utilized in connection with an embodiment of the invention. Referring to FIG. 1b, there is shown bursts a, . . . , h in frames 11 and 12. Two bursts in each of the frames 11 and 12, for example, the bursts 11a and 11b, and 12a and 12b, may be part of a multibursts 20 and 21, respectively, that may be assigned to the mobile terminal A to transmit data. Accordingly, the mobile terminal A may transmit data in 8-PSK modulated bursts in the bursts 11a and 11b of the multiburst 20, and voice information in GMSK modulated burst in the burst 12a of the multiburst 21. The burst 12b of the multiburst 21 may be unused.

Notwithstanding, various embodiments of the invention may utilize all bursts assigned to a mobile terminal by being able to send 8-PSK modulated burst and GMSK modulated burst within the same multiburst. FIG. 1c is a diagram illustrating exemplary GMSK modulated burst and 8-PSK modulated burst in the same GSM frame, in accordance with an embodiment of the invention. Referring to FIG. 1c, a single mobile terminal may transmit 8-PSK modulated bursts in bursts 11a and 11b of the multiburst 25, and a GMSK modulated burst in frame 12a and an 8-PSK modulated burst in frame 12b in the multiburst 26. In this manner, bursts assigned to a single mobile terminal may be used efficiently.

FIG. 1d is a block diagram of exemplary transmitter system of a mobile terminal, which may be utilized in connection with an embodiment of the invention. Referring to FIG. 1d, the mobile terminal 100 may comprise a baseband processor 102, a transmitter front end 104, a processor 106, and a memory block 108. The baseband processor 102 may comprise suitable logic, circuitry, and/or code that may be adapted to process baseband signals and to communicate the processed baseband signals to the transmitter front end 104. The processing may comprise digital filtering and/or modulation using the appropriate modulation scheme, such as, for example, GMSK or 8-PSK, and converting the baseband signal to an analog signal. The transmitter front end 104 may comprise suitable logic, circuitry, and/or code that may be adapted to amplify the processed baseband signals. The amplified signal may be communicated to an antenna for transmission.

The processor 106 may comprise suitable logic, circuitry, and/or code that may be adapted to control the operation of the transmitter front end 104 and/or the baseband processor 102. For example, the processor 106 may be utilized to update and/or modify programmable parameters and/or values in a plurality of components, devices, and/or processing elements in the transmitter front end 104 and/or the baseband processor 102. Control and/or data information may be transferred from at least one processor external to the mobile terminal 100 to the processor 106. Similarly, the processor 106 may transfer control and/or data information to at least one controller and/or processor external to the mobile terminal 100.

The processor 106 may utilize the received control and/or data information to determine the mode of operation of the transmitter front end 104. For example, the processor 106 may read and/or write data and/or status information to various registers in the baseband processor 102 and/or transmitter front end 104. Accordingly, the processor may indicate multiburst data that may be transmitted, the order in which the data may be transmitted, and the type of modulation for each burst of data. The memory block 108 may comprise suitable logic, circuitry, and/or code that may be adapted to store a plurality of control, status and/or data information. The information stored in memory block 108 may be transferred to the transmitter front end 104 from the memory block 108 via the processor 106.

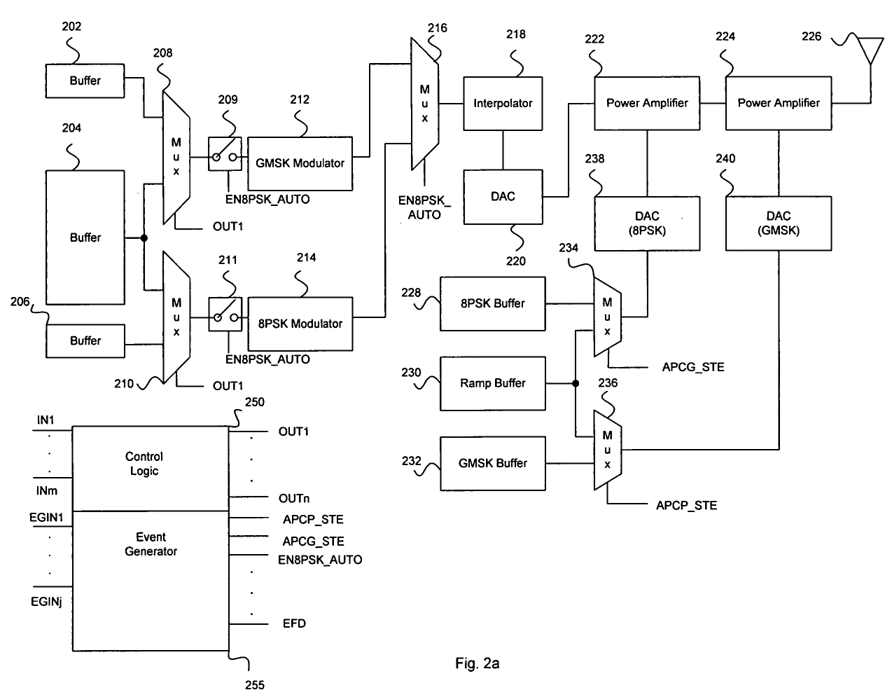

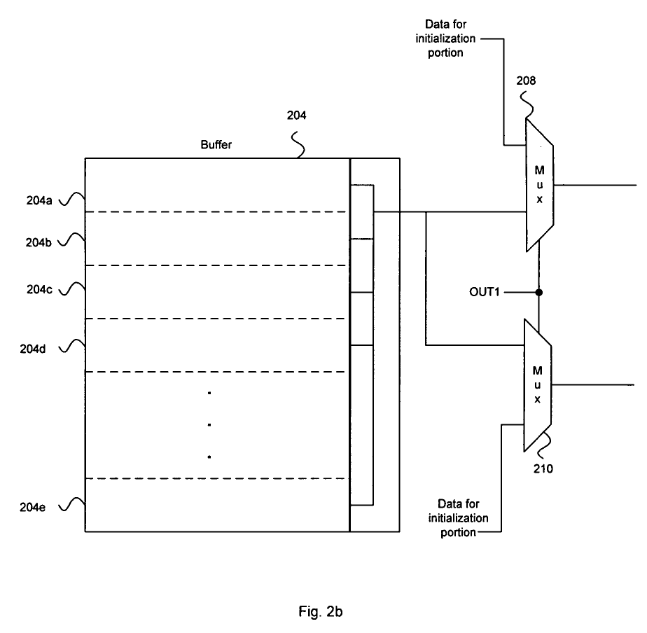

FIG. 2a is a block diagram of exemplary transmission path, in accordance with an embodiment of the invention. Referring to FIG. 2a, there is shown buffers 202, 204, 206, 228, 230, and 232, multiplexers 208, 210, 216, 234, and 236, switches 209 and 211, modulators 212 and 214, interpolator 218, digital to analog converters (DACs) 220, 238, and 240, power amplifiers 222 and 224, an antenna 226, control logic 250, and an event generator 255.

Outputs of the buffers 202 and 204 may be coupled to the inputs of the multiplexer 208, and outputs of the buffers 204 and 206 may be coupled to the inputs of the multiplexer 210. Each output of the multiplexers 218 and 210 may be coupled to an input of the modulators 212 and 214, respectively. Each output of the modulators 212 and 214 may be coupled to inputs of the multiplexer 216. An output of the multiplexer 216 may be coupled to an input of the interpolator 218, and an output of the interpolator 218 may be coupled to an input of the DAC 220. An output of the DAC 220 may be coupled to an input of the power amplifier 222, and an output of the power amplifier 222 may be coupled to an input of the power amplifier 224. An output of the power amplifier 224 may be coupled to the antenna 226.

Outputs of the buffers 228 and 230 may be coupled to inputs of the multiplexer 234, and an output of the multiplexer 234 may be coupled to an input of the DAC 238. An output of the DAC 238 may be coupled to a control input of the power amplifier 222. Outputs of the buffers 230 and 232 may be coupled to inputs of the multiplexer 236, and an output of the multiplexer 236 may be coupled to an input of the DAC 240. An output of the DAC 240 may be coupled to a control input of the power amplifier 224.

The control logic 250 may have an output signal OUT1 that may be used by the multiplexers 208 and 210 to select an input to transfer to an output. The event generator 255 may have output signal EN8PSK_AUTO that may indicate to the switches 209 and 211 whether to close the connection. The event generator 255 may also have outputs signals APCG_STE and APCP_STE that may be used by the multiplexers 234 and 236, respectively, to select an input to transfer to an output.

The buffers 202, 204, 206, 228, 230, and 232 may comprise suitable circuitry and/or logic that may be adapted to store data. For example, the processor 106 may store or buffer in the buffer 204 data that is to be transmitted. The processor 106 may store logic ones in the buffers 202 and 206 for transmission during an initialization period of the burst before the data from the buffer 204 may be transmitted during the data portion of the burst. Similarly, the processor 106 may store data in the buffers 228, 230, and 232 for use during ramp-up and ramp-down of a power level of the power amplifiers 222 and 224.

The multiplexers 208, 210, 216, 234, and 236 may comprise suitable circuitry and/or logic that may be adapted to transfer one of a plurality of inputs to an output. At least one signal, for example, the control signal OUT1 from the control logic 250, may indicate to the multiplexer 208 whether to transfer data from the buffer 202 or 204 to the output. At least one signal, for example, the control signal OUT1 from the control logic 250, may indicate to the multiplexer 210 whether to transfer data from the buffer 202 or 206 to the output. At least one signal, for example, the control signal EN8PSK_AUTO, may indicate to the multiplexer 216 whether to transfer data from the modulator 212 or 214 to the output. At least one signal, for example, the control signal APCG_STE, may indicate to the multiplexer 234 whether to transfer data from the buffer 228 or 230 to the output. At least one signal, for example, the control signal APCP_STE, may indicate to the multiplexer 236 whether to transfer data from the buffer 230 or 232 to the output. The switches 209 and 211 may open or close depending on at least one control signal, for example, a control signal EN8PSK_AUTO from the event generator 255.

The modulators 212 and 214 may comprise suitable circuitry, logic and/or code that may be adapted to digitally process a baseband signal. For example, the modulator 212 may process digital signals from the multiplexer 208 for GMSK modulation. Similarly, the modulator 214 may process digital signals from the multiplexer 210 for 8-PSK modulation.

The interpolator 218 may comprise suitable circuitry, logic and/or code that may be adapted to digitally process a signal to enhance the signal. For example, the interpolator 218 may digitally filter an input signal, for example, from the multiplexer 216, in order to attenuate unwanted signal components.

The DACs 220, 238, and 240 may comprise suitable circuitry and/or logic that may be adapted to receive a digital signal and convert it to an analog signal. For example, the DAC 220 may receive digital data from the interpolator 218 and communicate analog data to the power amplifier 222. The DACs 238 and 240 may receive digital data from the multiplexers 234 and 236, respectively, and provide analog signals to the power amplifiers 222 and 224, respectively.

The power amplifiers 222 and 224 may comprise suitable circuitry and/or logic that may be adapted to amplify an input signal. The analog signals from the DACs 238 and 240 may determine gain of the power amplifiers 222 and 224, respectively. The antenna 226 may receive an analog signal from the power amplifier 224 and transmit it.

The control logic 250 may comprise suitable logic and/or circuitry that may be adapted to provide output signals, for example, the output signals OUT1, . . . , OUTn. The output signals OUT1, . . . , OUTn may be generated from input signals, for example, input signals IN1, . . . , INm, where at least one of the input signals may be a clock signal. The output signal OUT1 may be, for example, communicated to the multiplexers 208 and 210 to control data to be transferred to the outputs of the multiplexers 208 and 210. The control logic may also interface to a processor and/or memory, for example, the processor 106 (FIG. 1d) and/or the memory block 108. Accordingly, data and/or commands may be communicated to the control logic 250, and status and/or data may be communicated to the processor 106 (FIG. 1d) and/or the memory block 108 (FIG. 1d).

The event generator 255 may comprise suitable logic and/or circuitry that may be adapted to provide output signals, for example, the output signals APCG_STE, APCP_STE, EN8PSK_AUTO, TXCALEN, TDACCKEN, ERUB, and EFD. The output signals may be generated from input signals, for example, input signals EGIN1, . . . , EGINj, where at least one of the input signals may be a clock signal.

The output signal APCG_STE and APCP_STE may control the outputs of the multiplexers 234 and 236, respectively. The output signal EN8PSK_AUTO may control the outputs of the multiplexer 216, as well as opening and closing of the switches 209 and 211. When the switch 209 and/or 211 is open, there may be no input signal for the modulator 212 and/or 214 to modulate. Accordingly, the modulators 209 and/or 211 may use less power. The output signal TXCALEN may be utilized to calibrate a DAC, for example, the DAC 214, as needed before each multiburst. The output signal TDACCKEN may be utilized for enabling a clock signal for a DAC, for example, the DAC 220, during transmission, and disabling the clock signal when the DAC 220 is not transmitting. Accordingly, the DAC 220 may use less power when it is not transmitting. The ramp-up/ramp-down signal ERUB may be utilized in ramping up and down the transmission power levels for the multibursts. The output signal EFD may be utilized in fetching data, for example, from the buffers 202 and 204, for transmission in the multibursts.

In operation, an output of the multiplexers 208 and 210 may be selected, and the corresponding switch 209 or 211, respectively, may be closed by a control signal. The inputs to the multiplexer 208 may be from the buffers 202 and 204. The inputs to the multiplexer 210 may be from the buffers 206 and 204. The data in the buffers 202 and 206 may be data that may be, for example, used for an initialization portion of a burst. The data in the buffer 204 may be data that is to be transmitted in a data portion of the burst. The data in the buffer 204 may be communicated to either the modulator 212 or the modulator 214 via the multiplexer 208 or the multiplexer 210, respectively, depending on the whether GMSK modulation or 8-PSK modulation, respectively, is used for transmission. If the modulator 212 and/or the modulator 214 is not used, for example, when there is no need for modulation of that type or there is no transmission of data, the modulators 212 and/or 214 may be powered down. Powering down may occur by an actual power down of the modulator 212 and/or the modulator 214, and/or turning off the clock signal, and/or opening the switch 209 and/or 211, respectively. Accordingly, the modulators 212 and/or 214 may dissipate power at a lower rate, if at all, in instances when there is no data to be transmitted using the respective GMSK or 8-PSK modulation. In certain instances when the clock signal to the modulators 212 and/or 214 is turned off when either or both are not modulating, or actual power down is used to reduce power dissipation, the switches 209 and 211 may not be needed.

The modulated signal from either the modulator 212 or the modulator 214 may be output by the multiplexer 216 to the interpolator 218. The interpolator 218 may process the modulated signal. The processing may comprise digitally filtering the input signal to attenuate unwanted signal components. The processed signal may be communicated to the DAC 220, which may convert the processed signal to an analog signal. The analog signal may be communicated to the power amplifier 222, and the output of the power amplifier 222 may be communicated to the power amplifier 224. The output of the power amplifier 224 may be communicated to the antenna 226. Each of the power amplifiers 222 and 224 may have its amplifying gain controlled by a control signal. For example, the gain of the power amplifier 222 may be controlled by the output of the DAC 238, and the gain of the power amplifier 224 may be controlled by the output of the DAC 240.

Inputs to the DACs 238 and 240 may be outputs of the multiplexers 234 and 236, respectively. The multiplexer 234 may have as inputs data from the buffers 228 and 230, and the multiplexer 236 may have as inputs data from the buffers 228 and 230. The buffer 230 may have ramp-up, ramp-down, and gain data for the power amplifier 222 when 8-PSK modulation is used. Similarly, the buffer 230 may have ramp-up, ramp-down, and gain data for the power amplifier 224 when the GMSK modulation is used. The buffer 228 may have a default gain data for the power amplifier 222 when the GMSK modulation is used, and the buffer 232 may have a default gain data for the power amplifier 224 when the 8-PSK modulation is used. Accordingly, the output of the power amplifier 224 may have the desired power level whether GMSK or 8-PSK modulation is used.

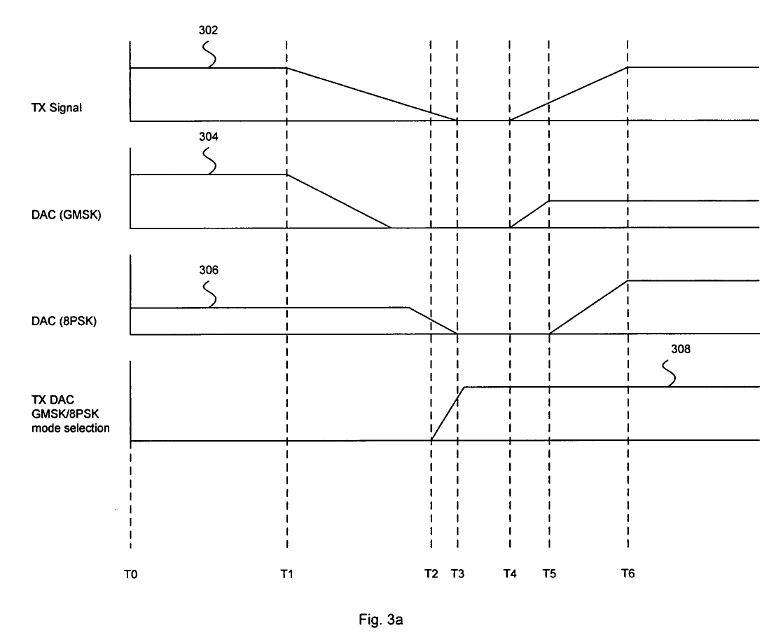

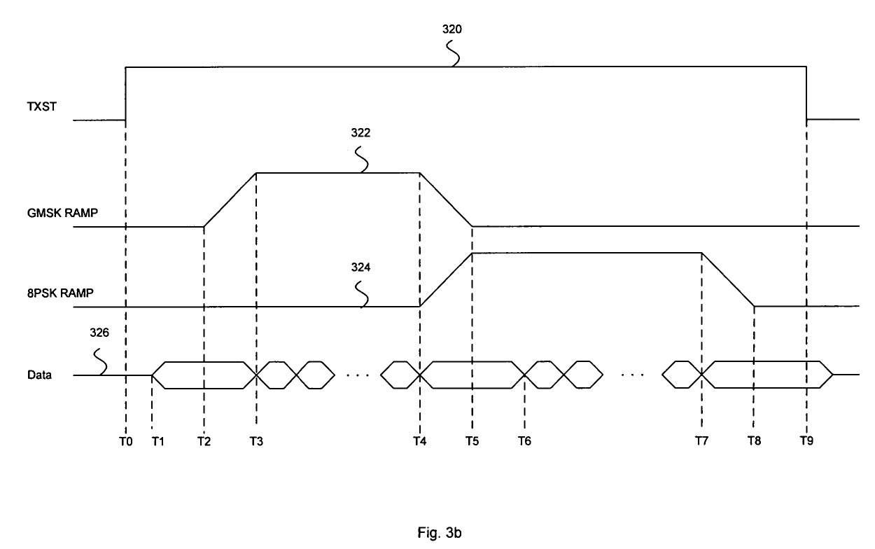

Although the power amplifier 222 may be suitable for amplifying 8-PSK modulated signals, and the power amplifier 224 may be suitable for amplifying GMSK modulated signals, both power amplifiers 222 and 224 may need to be turned on for both 8-PSK and GMSK modulation since the power amplifiers 222 and 224 are configured serially. When transmitting 8-PSK modulated signals, the power amplifier 224 may be turned on to a minimal gain, and the power level of the transmitted signal may be generally controlled by the gain of the power amplifier 222. Similarly, when transmitting GMSK modulated signals, the power amplifier 222 may be turned on to a minimal gain, and the power level of the transmitted signal may be generally controlled by the gain of the power amplifier 224. This is further described with regard to FIG. 3a.

An embodiment of the invention described in FIG. 2a is not to be presumed a limitation on the invention. For example, the multiplexers 234 and 236 may be replaced with switches, or the outputs of the multiplexers 206 and 208 may be communicated directly to the inputs of the modulators rather than via switches 209 and 211. Furthermore, although the buffers 202, 204, 206, 228, 230, and 232 may be shown as separate blocks, this may not be a limitation on the invention. The buffers 202, 204, 206, 228, 230, and 232 are separated to show functionality. Another embodiment of the invention may generate additional power levels by interpolating the data stored in the buffer 230.

FIG. 2b is a block diagram of exemplary buffer for storing data for GMSK modulation and 8-PSK modulation, in accordance with an embodiment of the invention. Referring to FIG. 2b, there is shown the buffer 204 and the multiplexers 208 and 210. The buffer 204 and the multiplexers 208 and 210 may be as described with respect to FIG. 2a.

The buffer 204 may comprise storage location 204a, 204b, 204c, 204d, . . . , 204e. The storage locations 204a, 204b, 204c 204d, . . . , 204e may each store data for a particular burst. For example, the multiburst 25 (FIG. 1c) may comprise two bursts, and the storage locations 204a and 204b may store data for 8-PSK modulated bursts, for example, the 8-PSK modulated bursts 11a and 11b (FIG. 1c). Accordingly, when the multiburst 25 comprising the data in the storage locations 204a and 204b is transmitted, the data from the respective storage locations 204a and 204b may be selected at appropriate times and communicated to the multiplexer 210.

Similarly, the multiburst 26 (FIG. 1c) may comprise two bursts, and the storage location 204a may store data for a GMSK modulated burst, for example, the GMSK modulated burst 12a (FIG. 1c), and the storage location 204b may store data for a 8-PSK modulated burst, for example, the 8-PSK modulated burst 12b (FIG. 1c). Accordingly, when the multiburst 26 comprising the data in the storage locations 204a and 204b is transmitted, the data from the respective storage locations 204a and 204b may be selected at appropriate times and communicated to the multiplexers 208 and 210. In this manner, bursts of different modulation types, for example, the 8-PSK modulated type and the GMSK modulated type, may be transmitted in a single GSM frame.

The capacity of each buffer location 204a, 204b, 204c, 204d, . . . , 204e may be design and/or implementation dependent. Each buffer location 204a, 204b, 204c, 204d, . . . , 204e may store data that may be, for example, for 8-PSK modulated burst or GMSK modulated burst. The GMSK modulated burst may comprise, for example, 88 bits for an access burst or 148 bits for the normal data burst. The 8-PSK modulated burst may comprise, for example, 148 bits for the normal data burst. For example, some embodiments of the invention may have the same buffer location size regardless of the modulation type and/or whether the data stored is for the access burst or normal data burst. Accordingly, the buffer location may be large enough to store the larger data size. In this manner, for example, the processor 106 (FIG. 1d) may load the appropriate data for the modulation type and/or access burst 12a and the normal data burst 12b in a multiburst and the start and end addresses for accessing data in each buffer location may be constant.

FIG. 3a is a timing diagram illustrating exemplary power ramp-up and ramp-down during transmission, in accordance with an embodiment of the invention. Referring to FIG. 3a, there is shown a transmitted signal 302, the GMSK DAC output signal 304, the 8-PSK DAC output signal 306, and a GMSK/8-PSK mode select signal 308.

At time instant T0, the GMSK/8-PSK mode select signal 308 may be deasserted to indicate that GMSK modulation may take place, and the transmitted signal 302 may be GMSK modulated. At time instant T1, data to be transmitted may have been completely transmitted and the power level of the power amplifier 224 (FIG. 2a) may be ramped down. Accordingly, the power of the signal transmitted by the antenna 226 (FIG. 2a) may be reduced until the transmitted signal 302 reaches a minimum level at time instant T3. The time instant T3 may also indicate when the sum of the GMSK DAC output signal 304, which may control the gain of the power amplifier 224, and the 8-PSK DAC output signal 306, which may control the gain of the power amplifier 222 (FIG. 2a), may be at a minimum value.

At time instant T2, the GMSK/8-PSK mode select signal 308 may be asserted to indicate that 8-PSK modulation may start. At time instant T4, the power amplifier 224 may be ramped up to a default power level, and at time instant T5, the power amplifier 222 may start to ramp up to the desired power level. At time instant T6, the RF signal transmitted by the antenna 226 may be ramped up to a desired power level and subsequent data may be transmitted. When the transmitted signal is decreased to a minimum level, for example, during the period of time between the time instants T3 and T4, power consumption may be reduced when there is no data transmitted.

Although the various signals may be shown as being asserted or deasserted at specific time instants, for example, the time instants T0, . . . , T6, the invention need not be so limited. Various embodiments of the invention may assert and deassert signals at different times instants with respect to each other, and this may be design and/or implementation dependent.

FIG. 3b is a timing diagram illutrating exemplary multiburst transmission, in accordance with an embodiment of the invention. Referring to FIG. 3b, there is shown a transmit start signal 320, a GMSK ramp signal 322, a 8-PSK ramp signal 324, and a data signal 326. The transmit start signal 320 may be asserted at time instant T0. This may allow generation of control signals for transmission of data. The time instants T1, T2, . . . , T9 may be delays with respect to the time instant T0. An embodiment of the invention may, for example, implement delays as multiples of a bit time during transmission and multiples of ¼ bit time during power ramp-up and ramp-down periods. The period of time from the time instant T0 to the time instant T1 may be when the transmit path circuitry powers up. The DAC 220 (FIG. 2a) may be calibrated during the period of time from the time instant T0 to the time instant T3.

Calibration of the DAC 220 may comprise setting an output of the DAC 220 to a desired value given a reference input signal. Accordingly, the output of the DAC 220 may be accurate with respect to a reference. Calibration may be desirable for the DAC 220 because the output of the DAC 220 may be amplified by the power amplifiers 222 and 224. Therefore, any inaccuracy in the output of the DAC 220 may be magnified by the amplification of the power amplifiers 222 and 224.

A first burst, for example, the GMSK modulated burst 12a, may begin transmitting at time instant T1. An initialization portion of the burst, which may comprise logic ones, may be transmitted as data 326 from the time instant T1 to the time instant T3. The time instant T2 may be when the GMSK modulated power level for the signal transmitted by the antenna 226 (FIG. 2a) starts to ramp up. At time instant T3, the desired power level may be reached, and a data portion of the first burst may be transmitted. The data portion may comprise user data for the normal burst type and system data for the access burst type. The data 326 that is GMSK modulated may be finished transmitting at time instant T4.

A second burst to be transmitted may be 8-PSK modulated. Therefore, the present RF power level for GMSK may need to be ramped down, and a new power level for the 8-PSK transmission may need to be ramped up. This may start at time instant T4 and finish at time instant T5. After the initialization portion, which may comprise logic ones, is transmitted, the 8-PSK data portion may be transmitted. The 8-PSK data portion may comprise user data. The 8-PSK data portion may be finished transmitting at time instant T7, and the power amplifiers 222 and 224 may be ramped down. Logic ones, which may be stored data in, for example, the buffer 202 or 206, may be transmitted during the period of time from the time instant T7 to the time instant T9. At time instant T8, the power amplifiers 222 and 224 may be ramped down, and at time instant T9 the transmit start signal 320 may be deasserted. Accordingly, an embodiment of the invention may allow GMSK modulated transmission and 8-PSK modulated transmission in the same multiburst.

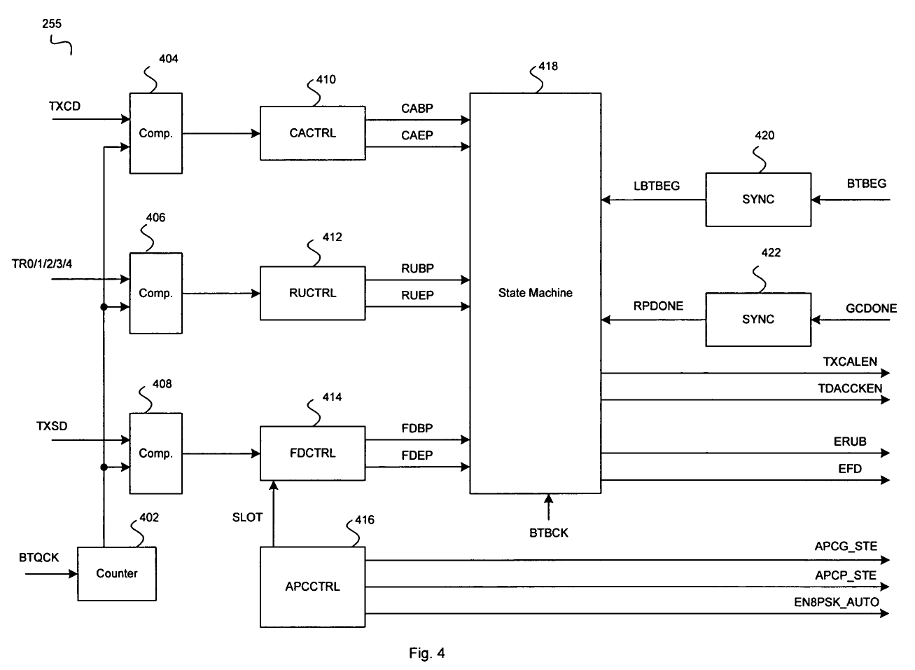

FIG. 4 is a block diagram illustrating exemplary event control circuitry, in accordance with an embodiment of the invention. Referring to FIG. 4, there is shown the event generator 255 (FIG. 2a) that comprises a counter 402, compare blocks 404, 406, and 408, a calibration control block 410, a ramp-up control block 412, a data fetch block 414, an automatic power control (APC) block 416, a state machine 418, and synchronization blocks 420 and 422.

The counter 402 may comprise suitable logic and/or circuitry that may be adapted to count, for example, a 13-bit value. The number of bits counted by the counter 402 may be design and/or implementation dependent. The counter 402 may communicate the 13-bit output to other blocks, for example, the compare blocks 404, 406, and 408. The counter 402 may be utilized to effectively provide delay timing in the compare blocks 404, 406, and 408 with respect to each other. For example, it may be desirable to have the output of the compare block 404 asserted three clock cycles after the output of the compare block 406 is asserted. Accordingly, the value communicated to the compare block 404 may be larger by three than the value communicated to the compare block 406. Since the output of the counter 402 is communicated to both compare blocks 404 and 406, the output of the compare block 404 may be asserted three clock cycles after the output of the compare block 406.

The compare blocks 404, 406, and 408 may comprise suitable logic and/or circuitry that may be adapted to compare two inputs and assert an output signal when the two inputs are equal. For example, the compare block 404 may have as inputs TXCD and the output of the counter 402. The calibration control block 410 may comprise suitable logic and/or circuitry that may be adapted to indicate a start and an end of a calibration period based on an input signal. The calibration period may be, for example, the period from the time instant T0 (FIG. 3b) to the time instant T1 (FIG. 3b), when a DAC, for example, the DAC 220 (FIG. 2a), may have its output calibrated to a desired value given a reference input. The ramp-up control block 412 may comprise suitable logic and/or circuitry that may be adapted to indicate start and end of a ramp up and ramp down periods based on an input signal. The data fetch block 414 may comprise suitable logic and/or circuitry that may be adapted to indicate, based on an input signal, when data may be transferred.

The APC block 416 may comprise suitable logic and/or circuitry that may be adapted to generate control signals that may be communicated to, for example, the switches 209 and 211, and/or the multiplexers 208, 210, 216, 234, and 236. The control signals may indicate to each of the multiplexers 208, 210, 216, 234, and 236 which input may be transferred to the output of the multiplexer.

The state machine 418 may comprise suitable logic and/or circuitry that may be adapted to generate control and/or state outputs that may be utilized in transmission of data using GMSK and/or 8-PSK modulation. The synchronization blocks 420 and 422 may comprise suitable logic and/or circuitry that may be adapted to receive input signals and synchronize them with respect to a clock used by another processing block. For example, the clock signal BTBCK used by the state machine 418 may be used by the synchronization blocks 420 and 422.

In operation, the counter 402 may be, for example, a 13-bit free running counter that may be clocked by a clock signal BTQCK. The clock signal BTQCK may be a quarter-bit period clock that may be active during data transmission period. The counter 402 may communicate the 13-bit count to each of the compare blocks 404, 406, and 408. Each of the compare blocks 404, 406, and 408 may compare the 13-bit value from the counter 402 to its respective input TXCD, TR0/1/2/3/4, or TXSD. Each of the compare blocks 404, 406, and 408 may assert an output signal when its respective inputs are equal to each other. For example, the compare block 404 may assert its output signal when the value of the signal TXCD is equal to the 13-bit value from the counter 402. The outputs of the compare blocks 404, 406, and 408 may be communicated to the calibration control block 410, the ramp-up control block 412, and the data fetch block 414, respectively.

The control blocks may indicate the start and end of a period with respect to its input signal. For example, the calibration control block 410 may output a calibration begin pulse signal CABP at an appropriate time to allow calibration of, for example, the DAC 220, at or after the time instant 0 (FIG. 3b). The calibration control block 410 may output a calibration end pulse signal CAEP at an appropriate time to allow data transmission to occur, for example, at time instant T1 (FIG. 3b). Similarly, the ramp-up control block 412 may output a begin ramp-up pulse signal RUBP that may indicate start of ramp-up and/or ramp-down period and an end ramp-up pulse signal RUEP that may indicate end of ramp-up and/or ramp-down period. The fetch data begin pulse signal FDBP from the data fetch control block 414 may indicate a start of a period when new data may be fetched for transmission. The fetch data end pulse signal FDEP from the data fetch control block 414 may indicate end of the period when new data may be fetched for transmission.

The state machine 418 may receive inputs from the calibration control block 410, the ramp-up control block 412, the data fetch block 414, as well as a synchronized baseband transmit begin signal LBTBEG from the SYNC block 420 and a synchronized ramp-up/ramp-down done signal RPDONE from the SYNC block 422. The state machine 418 may generate outputs, for example, a transmit calibration enable signal TXCALEN, a transmit DAC clock enable signal TDACCKEN, a ramp-up/ramp-down signal ERUB, and an enable fetch data signal EFD.

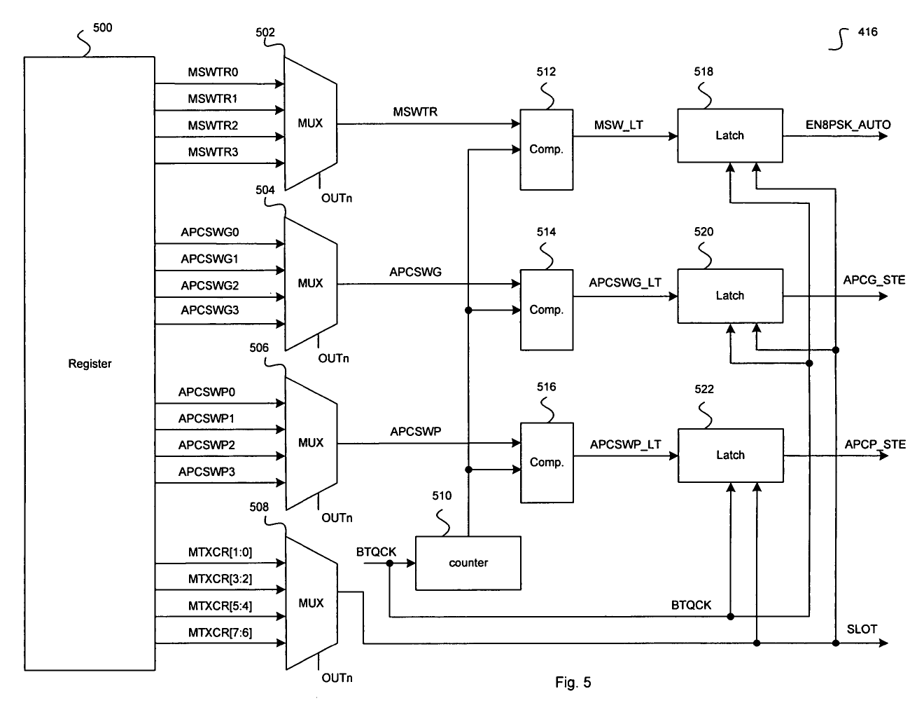

The APC block 416, which is described in more detail in FIG. 5, may generate a signal SLOT that may indicate to the data fetch control block 414 when a burst may start for transmission of data. The APC block 416 may also generate signals that may be utilized to control multiplexers and/or switches, such as, for example, the multiplexer 216, 234, and 236, and the switches 209 and 211. These signals may be, for example, APCG_STE, APCP_STE, and EN8PSK_AUTO.

FIG. 5 is a block diagram illustrating exemplary automatic power control block, in accordance with an embodiment of the invention. Referring to FIG. 5, there is shown the APC block 416 that comprises a register block 500, multiplexers 502, 504, 506, and 508, a counter 510, compare blocks 512, 514, and 516, and latches 518, 520, and 522.

Data may be written to the register block 500 by a processor, for example, the processor 106 (FIG. 1d), or by hardware, for example, the control logic 250 (FIG. 2a) that may transfer data from a memory, for example, the memory block 108 (FIG. 1d). The register block 500 may be similar to a buffer in that the register block may store data. The counter 510 may be a multi-bit counter. The compare blocks 512, 514, and 516 may be similar to the compare blocks with respect to FIG. 4.

The multiplexers 502, 504, 506, and 508 may receive inputs from the register block 500, and the outputs of the multiplexers 502, 504, and 506 may be communicated to the compare blocks 512, 514, and 516, respectively. At least one signal, for example, the signal OUTn which may comprise at least two bits, from the control logic 250 (FIG. 2a), may select the input to be transferred to the output of the multiplexers 502, 504, 506, and 508. The output of the multiplexer 508 may be a control signal SLOT. The control signal SLOT may be asserted for the period in which there may be data transmission. The control signal SLOT may be communicated to the data fetch control block 414 (FIG. 4) and to the latches 518, 520, and 522.

Each of the compare blocks 512, 514, and 516 may compare the signals MSWTR, APCSWG, and APCSWP, respectively, from the multiplexers 502, 504, and 506, respectively, with the output of the counter 510. The outputs of the compare blocks 512, 514, and 516 may be communicated to inputs of the latches 518, 520, and 522, respectively. The latches 518, 520, and 522 may generate output signals utilizing a clock signal, for example, the clock signal BTQCK that may be the same clock signal used by the counter 510, when the latches 518, 520, and 522 may be enabled by the control signal SLOT from the multiplexer 508. The outputs of the latches 518, 520, and 522 may be EN8PSK_AU0, APCG_STE, and APCP_STE, respectively.

In operation, each of the multiplexers 502, 504, 506, and 508 may receive four inputs from the register block 500. Each of the four inputs to each multiplexer may correspond to a burst that may be transmitted in a multiburst transmission. Each of the multiplexers 502, 504, 506, and 508 may receive a control signal, for example, the signal OUTn from the control logic 250, that may indicate which input to transfer to the output. Therefore, the signal OUTn may be based on the modulation of a burst in the multiburst transmission, as well as on the type of burst transmitted. The type of burst may be access burst type or normal data burst type.

The counter 510 may be clocked by the clock signal BTQCK, and the output of the counter 510 may be communicated to the compare blocks 512, 514, and 516. When each of the compare blocks 512, 514, and 516 receives a count from the counter 510 that matches the value of the signal from the respective multiplexer, the compare block may assert an output signal.

The latches 518, 520, and 522 may generate the output signals EN8PSK_AUTO, APCG_STE, and APCP_STE, respectively, using the clock signal BTQCK to latch the output signals from the compare blocks 512, 514, and 516, respectively. The latches 518, 520, and 522 may be enabled by the control signal SLOT. The control signal SLOT may indicate, for example, whether the burst transmission may be a GMSK burst transmission or an 8-PSK burst transmission. Accordingly, the latches 518, 520, and 522 may be enabled for specific types of transmissions. For example, the latches 518 and 522 may be enabled during 8-PSK burst transmission, and the latch 520 may be enabled during GMSK burst transmission.

One embodiment of the invention shown in FIG. 5 may support four bursts in a multiburst. However, the invention need not be limited in this manner. Accordingly, other embodiments of the invention may allow transmission of a multiple number of bursts other than four.

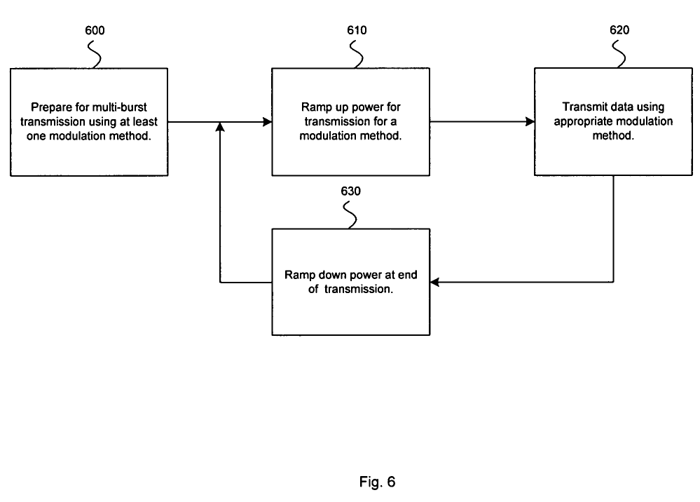

FIG. 6 is a flow diagram illustrating exemplary routine for GMSK/8-PSK mix-mode support, in accordance with an embodiment of the invention. In step 600, preparations may be made for a multiburst transmission using GMSK and/or 8-PSK modulation methods. In step 610, power may be ramped up for the appropriate modulation method. In step 620, appropriately modulated data may be amplified and transmitted. In step 630, the power may be ramped down after data transmission.

Referring to FIG. 6, and with respect to FIGS. 1, 2, 4, and 5, there is shown a plurality of steps 600 to 630 that may be utilized to support GMSK and/or 8-PSK modulation transmissions. In step 600, buffer and/or registers, for example, the data buffer 204 and the register block 500, respectively, may be loaded with data by, for example, the processor 106. The data in the data buffer 204 may comprise data that may be transmitted in a multiburst, which may comprise access burst and/or normal burst. GMSK modulation may be used for access bursts and/or normal bursts, while 8-PSK modulation may be used for normal bursts. The data in the register block 500 may comprise information regarding specific bursts in the multiburst. For example, the information in the register block 500 may comprise an indication of whether to use GMSK or 8-PSK modulation for a specific burst, switching time information to be used during power control ramp-up and ramp-down when modulation is changed between bursts, and timing information for controlling, for example, the output of the multiplexer 216. The multiplexer 216 may have as inputs modulated signals from the GMSK modulator and the 8-PSK modulator.

In step 610, appropriate power control may be executed for the burst modulation. For example, the power amplifiers 222 and 224 may be adjusted to output desired power such that signals modulated, for example, by GMSK modulation, may be transmitted by the antenna 226 at the correct power level. Similarly, the power amplifiers 222 and 224 may be adjusted to different output power levels if transmitted signals are to be modulated using 8-PSK modulation. This may be accomplished by using data in the buffer 228, 230, and 232. In an embodiment of the invention, the buffer 228 may have data that may control the output power level of the power amplifier 222 when GMSK modulation is required. Similarly, the buffer 232 may have data that may control the output power level of the power amplifier 224 when 8-PSK modulation is required. The buffer 230 may have data that may control the power amplifier 222 or 224 when 8-PSK modulation or GMSK modulation, respectively, is required. The control signals from the APC block 416 may indicate the input to be selected by the multiplexers 234 and 236.

In step 620, one of the output signals from the modulators 212 and 214 may be transferred to the output of the multiplexer 216. The transferred signal may be processed by the interpolator 218, the DAC 220, and amplified by the power amplifiers 222 and 224 before being transmitted by the antenna 226. In step 630, either the multi-burst may be finished, or the next burst may be modulated with a different modulation method. Accordingly, appropriate power control may be executed to ramp-down the power levels of the power amplifiers 222 and 224. Output of data from the buffers 204, 228, 230, and 232 may be controlled by control signals from, for example, the control logic 250 and/or the state machine 418.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for transmitting data, the method comprising transmitting bursts of different modulation types within a single GSM frame, wherein said different modulation types comprise a GMSK modulated type and an 8-PSK modulated type.

2. The method according to claim 1, further comprising modulating via said GMSK modulated type one of: a normal data burst type and an access burst type.

3. The method according to claim 1, further comprising storing data in memory to be transmitted in said single GSM frame.

4. The method according to claim 3, further comprising selecting at least a portion of said stored data for an initialization portion of said burst.

5. The method according to claim 3, further comprising selecting at least a portion of said stored data for a data portion of said burst.

6. The method according to claim 1, further comprising selecting one of said different modulation types for each of said transmitted bursts in said single GSM frame.

7. The method according to claim 1, further comprising ramping up transmit power prior to said transmitting of a first burst within said single GSM frame.

8. The method according to claim 7, further comprising storing a plurality of ramp-up values for use in said ramping up transmit power.

9. The method according to claim 8, further comprising interpolating additional ramp-up values from said stored said plurality of ramp-up values.

10. The method according to claim 9, further comprising generating an analog control signal to control said ramping up transmit power from at least one of the following: said stored said plurality of ramp-up values and said interpolated additional ramp-up values.

11. The method according to claim 1, further comprising ramping down transmit power after said transmitting of a last burst in said single GSM frame.

12. The method according to claim 11, further comprising storing a plurality of ramp-down values for use in said ramping down transmit power.

13. The method according to claim 12, further comprising interpolating additional ramp-down values from said stored said plurality of ramp-down values.

14. The method according to claim 13, further comprising generating an analog control signal to control said ramping down transmit power from at least one of the following: said stored said plurality of ramp-down values and said interpolated additional ramp-down values.

15. A system for transmitting data, the system comprising circuitry that transmits bursts of different modulation types within a single GSM frame, wherein said different modulation types comprise a GMSK modulated type and an 8-PSK modulated type.

16. The system according to claim 15, further comprising circuitry to modulate via said GMSK modulated type one of the following: a normal data burst type and an access burst type.

17. The system according to claim 15, further comprising circuitry that stores data in memory to be transmitted in said single GSM frame.

18. The system according to claim 17, further comprising circuitry that selects at least a portion of said stored data for an initialization portion of said burst.

19. The system according to claim 17, further comprising circuitry that selects at least a portion of said stored data for a data portion of said burst.

20. The system according to claim 15, further comprising circuitry that selects one of said different modulation types for each of said transmitted bursts in said single GSM frame.

21. The system according to claim 15, further comprising circuitry that ramps up transmit power prior to said transmitting of a first burst within said single GSM frame.

22. The system according to claim 21, further comprising circuitry that stores a plurality of ramp-up values for use in said ramping up transmit power.

23. The system according to claim 22, further comprising circuitry that interpolates additional ramp-up values from said stored said plurality of ramp-up values.

24. The system according to claim 23, further comprising circuitry that generates an analog control signal to control said ramping up transmit power from at least one of the following: said stored said plurality of ramp-up values and said interpolated additional ramp-up values.

25. The system according to claim 15, further comprising circuitry that ramps down transmit power after said transmitting of a last burst in said single GSM frame.

26. The system according to claim 25, further comprising circuitry that stores a plurality of ramp-down values for use in said ramping down transmit power.

27. The system according to claim 26, further comprising circuitry that interpolates additional ramp-down values from said stored said plurality of ramp-down values.

28. The system according to claim 27, further comprising circuitry that generates an analog control signal to control said ramping down transmit power from at least one of the following: said stored said plurality of ramp-down values and said interpolated additional ramp-down values.
